(19) United States
(12) Patent Application Publication
(10) Pub. No.: US 2006/0195586 A1
(43) Pub. Date: Aug. 31, 2006

(54) Sessions and terminals configured for binding in an extensible manner

(75) Inventors: Vladimir K. Stoyanov, Redmond, WA (US); Ara Bernardi, Mercer Island, WA (US); Costin Hagiu, Sammamish, WA (US); John E. Parsons JR., Sammamish, WA (US); Makarand V. Patwardhan, Redmond, WA (US); Sriram Sampath, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/067,296

(22) Filed: Feb. 25, 2005

(51) Int. Cl. G06F 15/16

(52) U.S. Cl. 709/227

(57) ABSTRACT

Systems and methods for configuring sessions and terminals for binding in an extensible manner are disclosed. In one implementation, a terminal is created in response to notification of an incoming connection. A session is also created. The terminal and session are bound together for operation. This implementation may be instantiated as computer-executable instructions defined on a computer-readable media.

### TECHNICAL FIELD

The present disclosure generally relates to sessions and terminals configured for binding in an extensible manner.

### BACKGROUND

A “session” may be configured to organize a group of applications and security tokens that share a subsystem within an operating system. Terminal functionality configured for use with the session may include hardware devices and associated software. Within conventional systems, the “terminal services” or similar software that creates session and terminal functionality has a composite structure. Because of this composite structure, different aspects of the software responsible for creation of session functionality are closely related and intertwined with aspects of the software responsible for creation of terminal functionality. Accordingly, any change required to either session or terminal aspects of the composite software used to create both sessions and terminals may result in a large number of interrelated changes, and the need to edit and re-compile large sections of code.

As part of an emerging trend, an increasing number of sessions having different type and specialization are being developed. Typical examples of such sessions include full desktop, Microsoft® eHome, sand-boxed sessions for multi-level security and protected admin. Additionally, an increasing number of terminals and terminal devices are also being developed. Because the composite software used by conventional systems must be heavily modified in response to a need for a change in either session or terminal functionality, a considerable amount of work must be done to known software in response to changes in aspects of session or terminal functional requirements.

### SUMMARY

Systems and methods for configuring sessions and terminals for binding in an extensible manner are disclosed. In one implementation, a terminal is created in response to notification of an incoming connection. A session is also created, and the terminal and session are bound together for operation. This implementation may be instantiated as computer-executable instructions defined on a computer-readable media.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a diagram illustrating an exemplary connection sequence.

FIG. 2 is a block diagram illustrating exemplary relationships within an implementation comprising a session manager, connection managers and a notification framework.

FIG. 3 illustrates an exemplary design pattern wherein a session manager is instantiated in software, thereby showing exemplary components and their relationships.

FIG. 4 is a flowchart illustrating one implementation whereby sessions and terminals are configured for binding in an extensible manner.

FIG. 5 is a flowchart illustrating exemplary aspects involving communication between functional blocks of software used to create sessions and terminals.

FIG. 6 is a flowchart illustrating exemplary aspects related to creation of sessions and terminals using two separate processes.

FIG. 7 is a flowchart illustrating exemplary aspects related to utilization of sessions and terminals.

FIG. 8 illustrates an exemplary computing environment suitable for configuring sessions and terminals for binding in an extensible manner.

### DETAILED DESCRIPTION

Overview

This disclosure discusses sessions and terminals configured for binding in an extensible manner. In a preferred embodiment, a session and a terminal are created by a session manager and a connection manager, respectively. In this embodiment, the session manager and connection manager are configured as separate processes. Once created, the session and terminal are bound together, thereby allowing the session to gain access to various I/O devices available from the terminal. Because the session and the terminal are created by separate processes, changes may be made to either process without requiring changes to, or recompilation of, the other process. Accordingly, new sessions and/or terminals may be created under conditions of improved efficiency and enhanced functionality.

Exemplary Environment

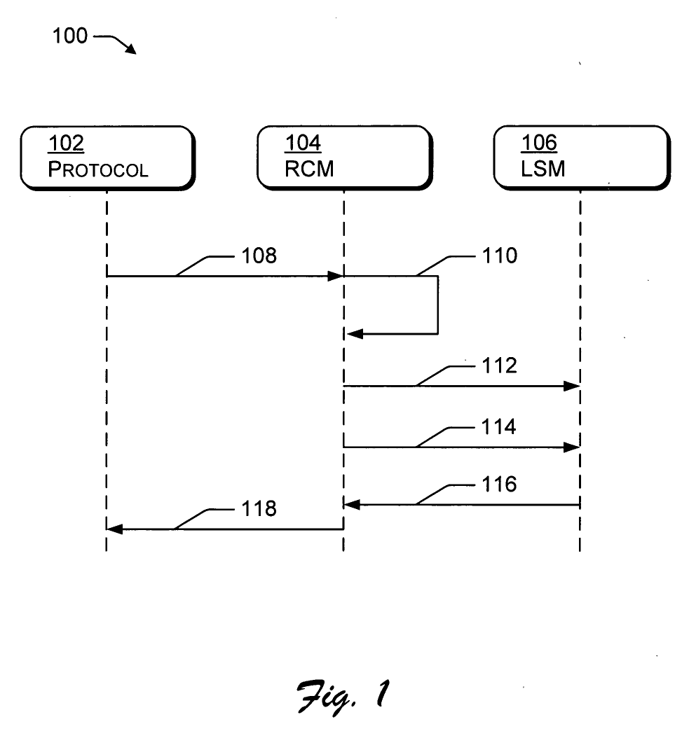

FIG. 1 is a diagram illustrating an exemplary connection sequence 100 by which extensible terminal(s) and session(s) are created and bound. Protocol 102 is configured to provide notification of events to objects or devices configured as extensions. In a typical embodiment, the protocol 102 is configured to support communication with a connection manager, such as remote connection manager 104. In the example of FIG. 1, the protocol 102 notifies a connection manager 104 of an incoming connection 108. The connection manager 104 may be configured as a remote connection manager (RCM) or as a local connection manager (LCM), depending on the implementation.

The incoming connection 108 is a request 110 for the connection manager 104 to create a local or remote terminal. The terminal created includes software supporting an indicated hardware or physical device, while local terminals also include that hardware and/or device. The software may include device drivers and other low-level objects, but typically includes abstractions instantiated by one or more layers of higher-level software. In implementations wherein the terminal is local, the physical devices included within the terminal may be referred to as a “glass terminal” or “console.”

Interactions 112-116 between sessions and terminals are representative of the communication typically involved in creating and binding terminals and sessions. At 112, the connection manager sends a request to the local session manager (LSM) 106 to create a session. The request is typically made by an API (applications programming interface), but could be made by any means consistent with the environment within which the sessions and terminals are operated.

In response to the creation of a session, at 114 the connection manager binds the newly created terminal to the newly created session. The communication 114 between the connection manager and the session manager may be implemented by use of an API or other available functionality, depending in part on the operating system environment.

In response to the binding of the session and terminal, the session manager gets 116 device handles associated with operation of the terminal. Communication to the connection manager is made utilizing a notification framework, using the protocol 102. At this point, notification 118 is made indicating that the connection is completed.

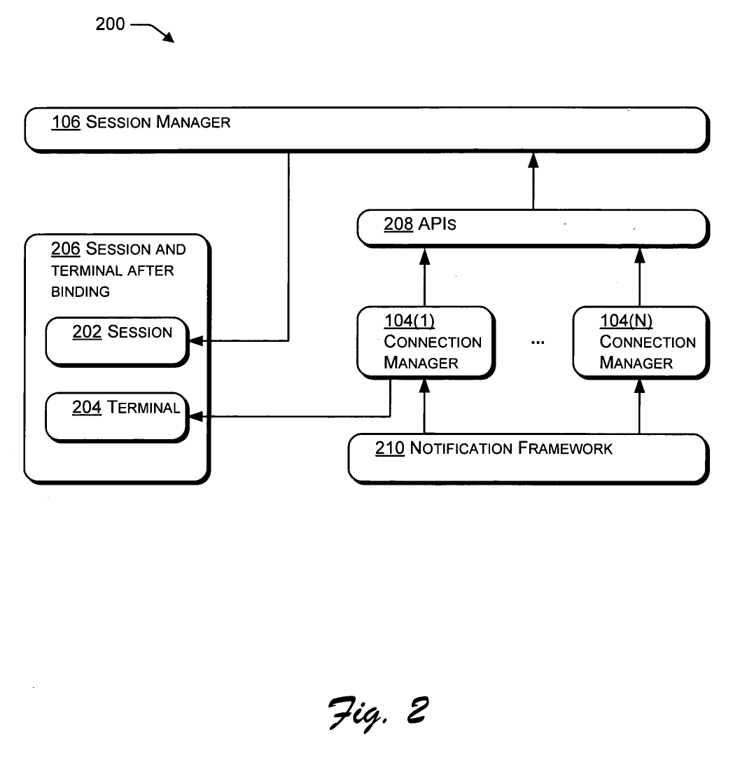

FIG. 2 is a block diagram 200 illustrating exemplary relationships between an implementation comprising a session manager 106, one or more connection managers 104(1-N) and a notification framework 210. The local session manager (LSM) 106 provides sessions that can be local or remove with respect to a terminal to which the user is logged onto. The session manager 106 is configured to create a session 202 upon request by a connection manager. The request is typically made via an API 208. In one embodiment, the session is configured to organize a group of applications and security tokens that share a subsystem within an operating system. For example, the applications could share the same Win32 subsystem. Sessions typically do not include I/O devices like a monitor, mouse or keyboard, which are included within the terminal. Accordingly, sessions must be bound to a terminal to be operable.

Each of one or more connection managers 104 is configured to create a terminal 204. In a typical implementation, each connection manager is configured to create a different type of terminal. For example, each connection manager may be associated with creation of a terminal intended for use with a different physical device (i.e. “glass terminal” or “console”). Terminal functionality may include hardware devices such as a monitor, keyboard and mouse or other pointing device, as well as lower-level software drivers associated with the hardware devices. Such devices are directly accessible to the user, and may include printers, smart card readers, audio systems, storage devices and others. Additionally, most implementations include higher-level software providing one or more layers of abstraction.

Instructions to the connection manager(s) are configured according to the protocol and arrive via the notification framework 210. For example, the incoming connection instruction 108 (FIG. 1) and requests for device handles 116 (FIG. 1) arrive via the notification framework 210.

Communications made by the connection manager(s) to the session manager 106 are made by appropriate APIs 208. For example, the instruction 112 (FIG. 1) to the session manager 106 to create the session 202 is typically made by an API 208, as well as instructions 114 (FIG. 1) associated with binding the session 202 to the terminal 204.

The session 202 and terminal 204 are bound together into a functional unit 206 having characteristics resulting from the underlying session 202 and terminal 204. It is an important aspect that the session 202 and the terminal 204 are created by the session manager 106 and the connection manager 104, respectively, and that changes to either the session manager or the connection manager do not necessitate changes to the other. Accordingly, where a different session or terminal is desired, a new or changed session manager or connection manager, respectively, may be required. However, these changes are expedited relative to the prior art because issues arising from intertwined code related to both session and terminal creation do not have to be addressed.

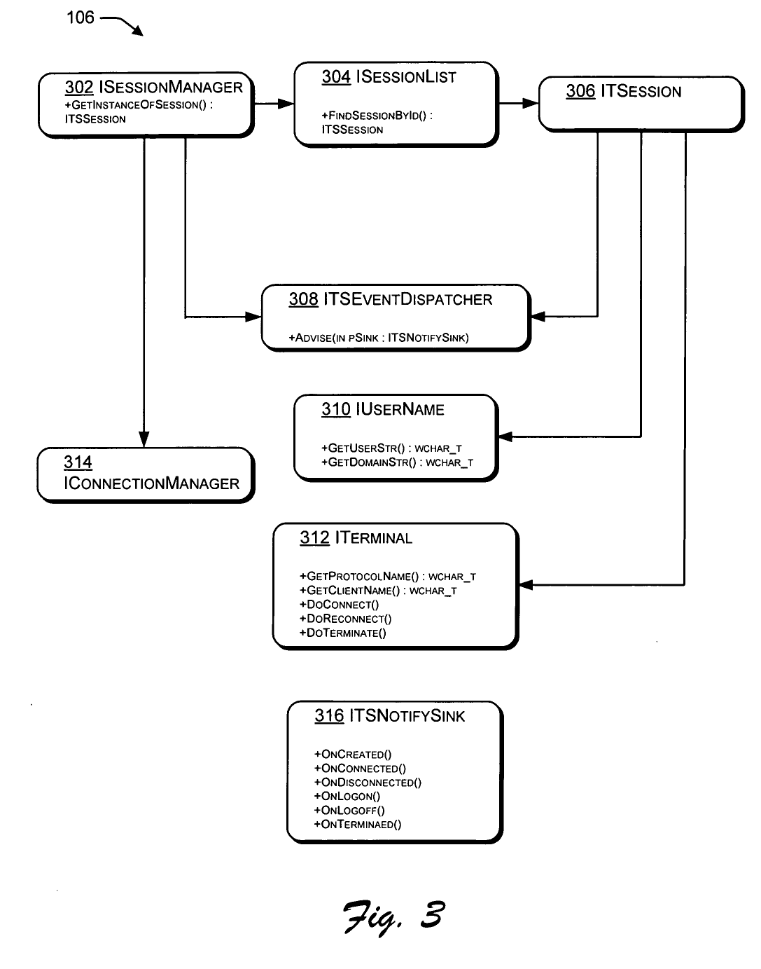

FIG. 3 illustrates an exemplary design pattern by which the session manager 106 may be instantiated in software. In particular, exemplary components and their relationships are shown. ISessionManager 302 is configured as a subroutine, procedure or object adapted to create an instance of a session 202 (FIG. 2) using GetInstanceOfSession( ). ISessionList 304 is configured as a subroutine, procedure or object to manage sessions using FindSessionById( ). Although a number of sessions could have been created by the ISessionManager 302, a single session ITSession 306, is shown. The notification framework 210 (FIG. 2) is instantiated by ITSEventDispatcher 308. The ITSEventDispatcher 308 allows the session 306 and session manager 302 to communicate with one or more connection managers 104 (FIGS. 1 and 2).

Each session may be associated with a user, and IUserName 310 is configured to identify a logged on user.

A terminal object, ITerminal 312, is created by the connection manager 314, and is a specific implementation of the generalized terminal object 204 of FIG. 2. After creation, the ITerminal 312 is bound to the ITSession 306 for operation. The binding process is typically performed by the connection manager, specifically implemented as 314 in FIG. 3, and seen in a generalized form as 104 in FIGS. 1 and 2.

One or more instances of the IConnectionManager 314 may be configured as plug-ins, or otherwise configured as extensions with respect to the session manager 106. Configured as extensions, the connections managers can be loaded by the session manager 106 and executed in-procedure, or may be run out-of-procedure as COM objects. In most implementations, running out-of-procedure is preferred. Each IConnectionManager 314 is configured to create a terminal 204 (see FIGS. 1 and 2) having specific characteristics. Selection of a particular IConnectionManager 314 will result in a particular terminal having desired characteristics.

ITSNotifySink 316 is related to the ITSEventDispatcher 308, and includes software implementing methods and functions that support aspects of the notification subsystem or framework 210.

Exemplary Methods

Exemplary methods for creating and binding sessions and terminal in an extensible manner will now be described with primary reference to the flow diagrams of FIGS. 4-7. The methods apply generally to the operation of exemplary components discussed above with respect to FIGS. 1-3. The elements of the described methods may be performed by any appropriate means including, for example, hardware logic blocks on an ASIC or by the execution software including processor-readable instructions defined on a processor-readable medium. A “processor-readable medium,” as used herein, can be any means that can contain, store, communicate, propagate, or transport instructions for use by or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection having one or more wires, a portable computer diskette, a random access memory (RAM), a read-only memory (ROM), an erasable programmable-read-only memory (EPROM or Flash memory), an optical fiber, a rewritable compact disc (CD-RW), and a portable compact disc read-only memory (CDROM).

FIG. 4 shows a flowchart 400 illustrating an implementation of extensible terminal, session and binding configurations. At block 402, notification is made of an incoming connection. Typically, the notification is made to the connection manager 104 (FIG. 2) using the framework 210 (FIG. 2). The notification may be made using the protocol 102 (FIG. 1).

At block 404, a terminal 204 (FIG. 2) is created in response to notification by the protocol 102 (FIG. 1). In the generalized embodiment of FIG. 2, the terminal 204 is created by the connection manager 104. In the specific implementation of FIG. 3, the terminal is created by the IConnectionManager 314. The terminal includes low-level I/O device drivers, as well as higher-level software layers associated with concepts that are more abstract. In one possible implementation of block 404, seen at block 406, the terminal is created using a connection manager configured to create the terminal according to requirements indicated by the incoming connection. Accordingly, a connection manager configured to create a desired terminal may be selected from among two or more connection managers according to the type of terminal desired, thereby allowing creation of any desired terminal type for which an associated connection manager is available.

In a further implementation of block 404, at block 408 the terminal is created independently of the session to which the terminal is to be bound. In a preferred implementation, the terminal is created by an out-of-procedure execution of a plug-in, while the session is created by an application configured to accept the plug-in. In an alternative implementation, the terminal is created by a plug-in loaded and run in-process within the session manager. Both implementations provide for independent creation of the session and terminal. By creating a desired terminal independently of the session, changes made to the connection manager to modify characteristics of the terminal created will not require extensive revision of the session manager and/or session, and vice versa.

At block 410, a session is created for use with the terminal in response to a request made by a connection manager to a session manager. Referring to FIG. 1 for an example of this creation, the connection manager 104 makes a request 112 to the session manager 106 to create the session. Referring to FIG. 2 for a second example of this creation, the connection manager 104 makes a request using API 208 to the session manager 106 to create the session.

At block 412, the session is bound to the terminal. In the example illustrated in FIGS. 1-3, the session 202 is bound to the terminal 204 by the connection manager 104. At block 414, binding the session to the terminal results in acquisition by the session of certain I/O devices from the newly associated terminal. In particular, the terminal may make available to the session a set of opened device handles that identify some or all of the following devices: keyboard, mouse, video, sound and (optionally) protocol. The set of devices is not limited to just these, and a terminal may implement additional devices like a USB cameras or printer. However, these devices are typical of those involved. An example of the acquisition of the device handles is seen in FIG. 1 at 116, wherein a request for the device handles is made by the LSM (local session manager) 106 to the RCM (remote connection manager) 104.

At block 416, the session is disconnected from the terminal. Optionally, the session may be bound to a second, newly created or already existing, terminal. Binding the session to a second terminal allows the session to be reused, and also allows continuity in the applications running on the session during the transition from a first terminal to a second terminal.

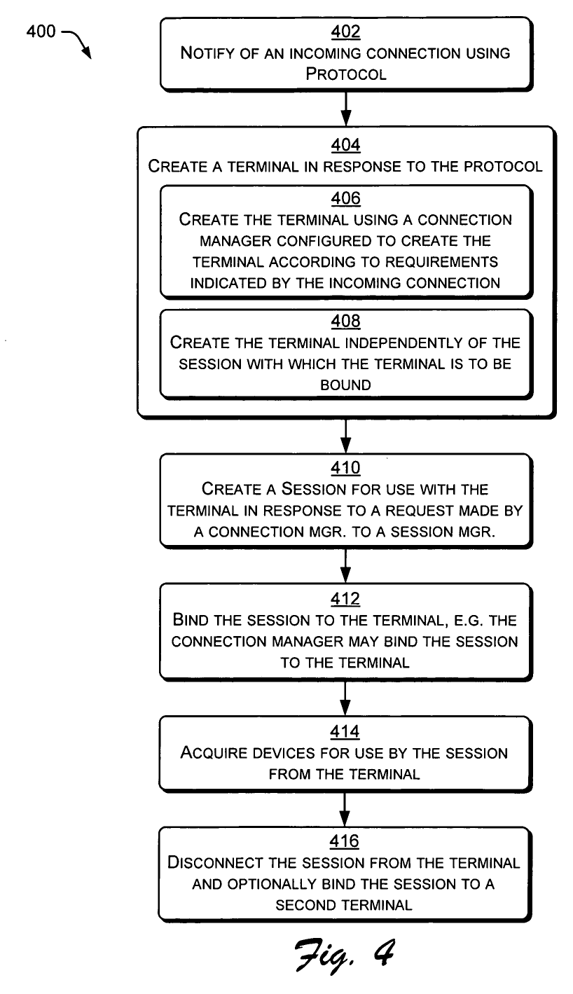

FIG. 5 is a flowchart 500 illustrating additional aspects of an implementation wherein sessions and terminals are configured for binding in an extensible manner. In particular, flowchart 500 illustrates aspects whereby the components of the implementations of FIGS. 1-3 communicate. These aspects may be implemented before, after or simultaneously with events in other flowcharts.

At block 502, a notification framework configured in an extensible manner is operated according to an event-based model. The framework 210 of FIGS. 2-3 is exemplary of a notification framework configured in an extensible manner according to an event-based model. At block 504, an implementation of the notification framework is seen. In particular, extensions such as connection managers 104 (FIGS. 1-3) are notified of events through the framework. In the implementation of FIGS. 2-3, the framework 210 utilizes the protocol 102 of FIG. 1 to provide notice of events to the connection manager(s) 104. In another example, FIG. 1 illustrates how the protocol 102 notifies of an incoming connection 108.

At block 506, APIs are utilized to communicate from the connection manager(s) to the session manager. For example, in FIG. 1, APIs are utilized by the connection manager 104 at 112 to communicate the need for the session manage 106 to create a session and at 114 to bind the session to the terminal. FIG. 2 illustrates an exemplary connection, wherein the connection manager(s) utilize APIs to communicate with the session manager.

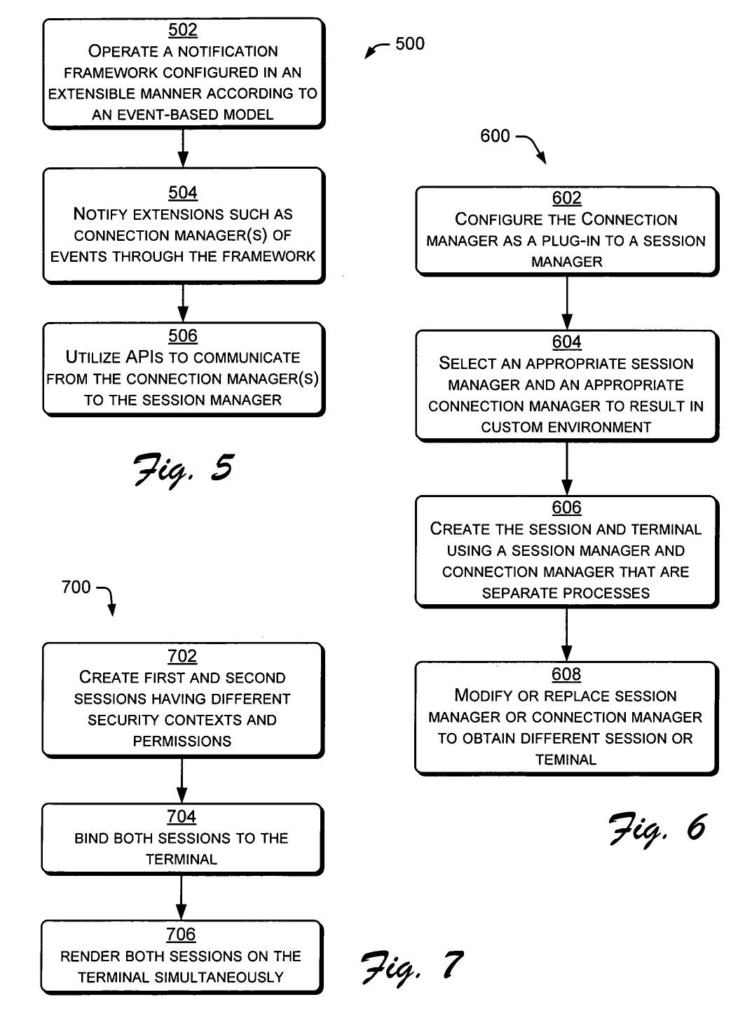

FIG. 6 is a flowchart 600 illustrating additional aspects of sessions and terminals configured for binding in an extensible manner. In particular, flowchart 600 describes aspects related to creating the session and the terminal using separate processes. At block 602, the connection manager is configured as a plug-in to a session manager. While different configurations for the session manager are easily envisioned, configuring the connection manager as a plug-in to the session manager allows for convenient installation of newly developed connection managers. For example, if a new terminal configuration is envisioned, a new connection manager may be designed to create the new terminal. The new connection manager may then be installed as a plug-in to the session manager. For example, FIG. 2 shows an implementation wherein connection managers 104 are configured as plug-ins to the session manager 106, and communicate to the session manager by means of APIs.

At block 604, an appropriate connection manager and an appropriate session manager are selected to result in creation of an appropriate terminal and an appropriate session, respectively. By creating the appropriate terminal and session individually, the resulting the environment created upon binding the session and the terminal together may be selected in a customizable manner.

At block 606, the session and terminal are created using a session manager and a connection manager that are separate processes. Accordingly, the session is created independently from the terminal. In an example discussed previously with respect to FIG. 3, the IConnectionManager 314 is configured to accept connection managers configured as plug-ins. This allows the connection manager to be run out-of-proc as a COM object, and provides a mechanism by which the session manager and connection manager may be configured as separate processes.

At block 608, the session manager or the connection manager may be modified or replaced to obtain a different session or terminal, respectively. Because the session manager and the connection manager are separate processes, replacement or modification of one process does not require replacement of modification of the other process. For example, if a new terminal is required, then a new connection manager may be installed as a plug-in to the session manager, without any need to modify the session manager.

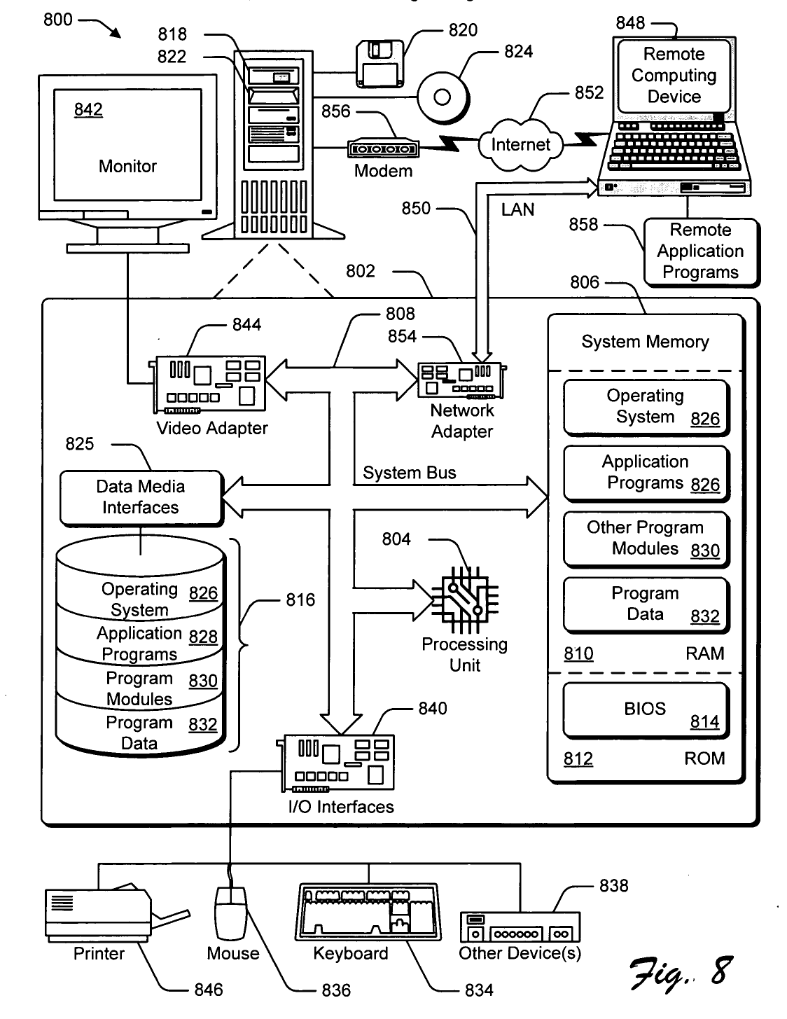

FIG. 7 is a flowchart 700 illustrating additional aspects of an implementation of sessions and terminals configured for binding in an extensible manner. In particular, FIG. 7 shows aspects of binding and disconnecting sessions to terminals to facilitate additional functionality. At block 702, first and second sessions are created, wherein the sessions have different security contexts and permissions. At block 704, both sessions are bound to a single terminal. At block 706, the sessions are both rendered simultaneously on the terminal.

While one or more methods have been disclosed by means of flow diagrams and text associated with the blocks of the flow diagrams, it is to be understood that the blocks do not necessarily have to be performed in the order in which they were presented, and that an alternative order may result in similar advantages. Furthermore, the methods are not exclusive and can be performed alone or in combination with one another.

Exemplary Computer

FIG. 8 illustrates an exemplary computing environment suitable for implementing extensible terminal, session and binding configurations.

The computing environment 800 includes a general-purpose computing system in the form of a computer 802. The components of computer 802 can include, but are not limited to, one or more processors or processing units 804, a system memory 806, and a system bus 808 that couples various system components including the processor 804 to the system memory 806. The system bus 808 represents one or more of any of several types of bus structures, including a memory bus or memory controller, a peripheral bus, a Peripheral Component Interconnect (PCI) bus, an accelerated graphics port, and a processor or local bus using any of a variety of bus architectures.

Computer 802 typically includes a variety of computer readable media. Such media can be any available media that is accessible by computer 802 and includes both volatile and non-volatile media, removable and non-removable media. The system memory 806 includes computer readable media in the form of volatile memory, such as random access memory (RAM) 810, and/or non-volatile memory, such as read only memory (ROM) 812. A basic input/output system (BIOS) 814, containing the basic routines that help to transfer information between elements within computer 802, such as during start-up, is stored in ROM 812. RAM 810 typically contains data and/or program modules that are immediately accessible to and/or presently operated on by the processing unit 804.

Computer 802 can also include other removable/non-removable, volatile/non-volatile computer storage media. By way of example, FIG. 8 illustrates a hard disk drive 816 for reading from and writing to a non-removable, non-volatile magnetic media (not shown), a magnetic disk drive 818 for reading from and writing to a removable, non-volatile magnetic disk 820 (e.g., a “floppy disk”), and an optical disk drive 822 for reading from and/or writing to a removable, non-volatile optical disk 824 such as a CD-ROM, DVD-ROM, or other optical media. The hard disk drive 816, magnetic disk drive 818, and optical disk drive 822 are each connected to the system bus 808 by one or more data media interfaces 825. Alternatively, the hard disk drive 816, magnetic disk drive 818, and optical disk drive 822 can be connected to the system bus 808 by a SCSI interface (not shown).

The disk drives and their associated computer-readable media provide non-volatile storage of computer readable instructions, data structures, program modules, and other data for computer 802. Although the example illustrates a hard disk 816, a removable magnetic disk 820, and a removable optical disk 824, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 816, magnetic disk 820, optical disk 824, ROM 812, and/or RAM 810, including by way of example, an operating system 826, one or more application programs 828, other program modules 830, and program data 832. Each of such operating system 826, one or more application programs 828, other program modules 830, and program data 832 (or some combination thereof) may include an embodiment of a caching scheme for user network access information.

Computer 802 can include a variety of computer/processor readable media identified as communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computer system 802 via input devices such as a keyboard 834 and a pointing device 836 (e.g., a “mouse”). Other input devices 838 (not shown specifically) may include a microphone, joystick, game pad, satellite dish, serial port, scanner, and/or the like. These and other input devices are connected to the processing unit 804 via input/output interfaces 840 that are coupled to the system bus 808, but may be connected by other interface and bus structures, such as a parallel port, game port, or a universal serial bus (USB).

A monitor 842 or other type of display device can also be connected to the system bus 808 via an interface, such as a video adapter 844. In addition to the monitor 842, other output peripheral devices can include components such as speakers (not shown) and a printer 846 that can be connected to computer 802 via the input/output interfaces 840.

Computer 802 can operate in a networked environment using logical connections to one or more remote computers, such as a remote computing device 848. By way of example, the remote computing device 848 can be a personal computer, portable computer, a server, a router, a network computer, a peer device or other common network node, and the like. The remote computing device 848 is illustrated as a portable computer that can include many or all of the elements and features described herein relative to computer system 802.

Logical connections between computer 802 and the remote computer 848 are depicted as a local area network (LAN) 850 and a general wide area network (WAN) 852. Such networking environments are commonplace in offices, enterprise-wide computer networks, intranets, and the Internet. When implemented in a LAN networking environment, the computer 802 is connected to a local network 850 via a network interface or adapter 854. When implemented in a WAN networking environment, the computer 802 typically includes a modem 856 or other means for establishing communications over the wide network 852. The modem 856, which can be internal or external to computer 802, can be connected to the system bus 808 via the input/output interfaces 840 or other appropriate mechanisms. It is to be appreciated that the illustrated network connections are exemplary and that other means of establishing communication link(s) between the computers 802 and 848 can be employed.

In a networked environment, such as that illustrated with computing environment 800, program modules depicted relative to the computer 802, or portions thereof, may be stored in a remote memory storage device. By way of example, remote application programs 858 reside on a memory device of remote computer 848. For purposes of illustration, application programs and other executable program components, such as the operating system, are illustrated herein as discrete blocks, although it is recognized that such programs and components reside at various times in different storage components of the computer system 802, and are executed by the data processor(s) of the computer.

### CONCLUSION

Although aspects of this disclosure include language specifically describing structural and/or methodological features of preferred embodiments, it is to be understood that the appended claims are not limited to the specific features or acts described. Rather, the specific features and acts are disclosed only as exemplary implementations, and are representative of more general concepts.

1. One or more computer-readable media comprising computer-executable instructions for creating sessions and terminals for binding in an extensible manner, the computer-executable instructions comprising instructions for:
creating a terminal in response to notification of an incoming connection;
creating a session; and
binding the session to the terminal.

2. The one or more computer-readable media of claim 1, wherein creating the terminal comprises instructions for:
creating the terminal independently of creating the session with which the terminal is to be bound.

3. The one or more computer-readable media of claim 1, wherein creating the terminal comprises instructions for:
creating the terminal using a connection manager configured to create the terminal according to requirements indicated by the incoming connection;
wherein the connection manager is configured as a plug-in to a session manager; and
wherein the session manager creating the session and is a separate process from the connection manager.

4. The one or more computer-readable media of claim 1, wherein notification of the incoming connection is facilitated by instructions for:
operating a notification framework configured according to an event-based model wherein an appropriate connection manager is called to create a terminal type as indicated by the notification.

5. The one or more computer-readable media of claim 1:
wherein instructions for creating the terminal and for creating the session are configured in separate processes; and
wherein either of the separate processes may be modified or replaced to create a different terminal or session, without revision of the other process.

6. The one or more computer-readable media of claim 1, wherein creating the session comprises instructions for:
utilizing an API to communicate from a connection manager configured to create the terminal to a session manager configured to create the session, to request creation of the session.

7. The one or more computer-readable media of claim 1, additionally comprising instructions for:
creating a second session; and
rendering the session and the second session on the terminal simultaneously.

8. The one or more computer-readable media of claim 7, additionally comprising instructions for:
creating the session and the second session to have different security contexts and permission to access to different resources.

9. The one or more computer-readable media of claim 1, additionally comprising instructions for:
notifying one or more connection managers of events through an extensible framework, wherein the one or more connection managers are configured as plug-ins to a session manager and wherein the terminal was created by one of the one or more connection managers; and
communicating information from the one or more connection managers to the session manager using APIs, wherein the session manager created the session.

10. One or more computer-readable media comprising computer-executable instructions for implementing an architecture to create and bind sessions and terminals, the computer-executable instructions comprising instructions for:
creating a terminal in response to notification by a protocol;
creating a session for use with the terminal;
binding the session to the terminal; and
wherein creating the terminal and creating the session are performed by different processes.

11. The one or more computer-readable media of claim 10, wherein creating the terminal comprises instructions for:
selecting an appropriate connection manager based on a desired terminal; and
wherein the selected connection manager is configured as an extension to a session manager that created the session.

12. The one or more computer-readable media of claim 10, wherein the protocol comprises instructions for implementing a notification framework configured to allow extensions to receive notification of events.

13. The one or more computer-readable media of claim 10, wherein creating the session for use with the terminal comprises instructions for:
creating the session with a session manager in response to an API sent by a connection manager that created the terminal.

14. The one or more computer-readable media of claim 10, wherein binding the session to the terminal comprises instructions for:
acquiring by the session of I/O devices from the terminal.

15. The one or more computer-readable media of claim 10, additionally comprising instructions for:
disconnecting the session from the terminal;
creating a second terminal; and
binding the session to the second terminal.

16. An architecture configured to create sessions and terminals for binding in an extensible manner, comprising:
a session manager to create sessions;
a connection manager to create terminals and to bind a session created by the session manager to a terminal created by the connection manager; and
a notification framework to notify the connection manager of events.

17. The architecture of claim 16, wherein:
the session manager and the connection manager are separately defined processes; and
wherein the connection manager and session manager may be independently altered to result in creation of a different session type or terminal type, respectively.

18. The architecture of claim 16, wherein the session manager comprises:
a subsystem to which extensions may be connected; and
wherein extensions may be connected to, and disconnected from, the subsystem without requiring recompilation of the session manager.

19. The architecture of claim 16, additionally comprising:
a plug-in structure communicating with the session manager and configured to allow out-of-process execution of plug-ins; and
wherein the connection manager is configured as a plug-in compatible with the plug-in structure.

20. The architecture of claim 16, wherein selection of an appropriate connection manager of may be made to result in creation of a desired terminal, and wherein the session and the desired terminal may be bound to create a custom environment.
